(19) United States
(12) Patent Application Publication
(10) Pub. No.: US 2008/0163306 A1
(43) Pub. Date: Jul. 3, 2008

(54) Information recording/reproducing apparatus

(75) Inventor: Yosuke Sonoda, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 11/979,599

(22) Filed: Nov. 6, 2007

(30) Foreign Application Priority Data
Dec. 28, 2006 (JP) 2006-353790

(51) Int. Cl. G06F 3/00

(52) U.S. Cl. 725/58

(57) ABSTRACT

After programmed recording start time arrives and recording for a target program is started, EPG information is periodically monitored and it is determined whether or not there is target program extension information in the EPG information when it is determined that a first extension flag is turned on. When it is determined that there is the target program extension information, programmed recording end time for the target program is changed by delaying the end time by an amount indicated by the target program extension information. When the changed programmed recording end time arrives, the recording of the target program stops. With this arrangement, it is possible to record the target program entirely even if scheduled end time of broadcasting delays.

This application is based on Japanese Patent Application No. 2006-353790 filed on Dec. 28, 2006, the contents of which are hereby incorporated by reference.

### BACKGROUND OF THE INVENTION

1. Field of the Invention

The present invention relates to an information recording/reproducing apparatus for recording and reproducing TV programs or other information to and from a recording medium, and particularly relates to a process of programmed recording function for setting a recording start time or a recording end time when a TV program is timer recorded.

2. Description of Related Art

Conventionally, an information recording/reproducing apparatus such as a hard disk apparatus (hard disk recorder), an optical disc apparatus (DVD recorder), or a magnetic tape apparatus (VCR) is equipped with a programmed recording function for timer recording a TV program that a user wishes to record. This type of information recording/reproducing apparatus having such a programmed recording function stores the channel of the TV program, the programmed recording start time, and the programmed recording end time in a flash memory. When the current time clocked by a timer reaches the programmed recording start time, the recording is started by recording the TV program broadcast from a television station indicated by the channel that was pre-programmed, and, when the current time reaches the programmed recording end time, the recording of the TV program is stopped.

If there is a sport program such as a live baseball game before the desired program to be timer recorded, the broadcast of such a sport program sometimes ends later than it is scheduled. In such a case, the broadcasting time is sometimes extended until the end of the actual game. For example, it is assumed that a baseball game program which is supposed to be broadcast from 7:00 p.m. to 9:00 p.m. is extended by 30 minutes and ends at 9:30 p.m. However, in order to timer record a drama program which is supposed to start from 9:00 p.m., the programmed recording start time in the information recording/reproducing apparatus is set to 9:00 p.m. Then, the information recording/reproducing apparatus starts recording from 9:00 p.m. to record the baseball game program for the first 30 minutes which correspond to the extended time of the broadcasting of the baseball game, and the recording of the drama starts thereafter, 30 minutes later than originally scheduled.

Moreover, when the drama was originally scheduled to be broadcast from 9:00 p.m. to 11:00 p.m., the drama is actually broadcast from 9:30 p.m. because the broadcasting of the baseball game is extended by 30 minutes. However, if the recording from 9:00 p.m. is programmed for two hours or is programmed to end at 11:00 p.m., the baseball game is recorded for the first 30 minutes and the drama is recorded for only the remaining 90 minutes. In addition, even if the recording period is extended for another 30 minutes to record the entire drama program of which the start of the broadcasting time is delayed, there are some cases in which the recording medium has no more space to record. In such a case, the required recording period goes beyond the possible recordable period, and the target program to be recorded may not be entirely recorded.

In view of this, in JP-A-2006-148714, when the previous program preceding the target program whose recording start time has been programmed is extended, a video recorder compares the voice of a specific person in the previous program before the previous program is supposed to end with the voice of a specific person in the program after the previous program is supposed to end. When the two voices are determined to be different, an extended period is obtained by subtracting the time on which the previous program is supposed to end from the time on which the two voices are found to be different, and, then, the extended period is added to the original recording start time for the target program so that a new recording start time is set. However, before the previous program is supposed to end, if there are, for example, two announcers, one in the studio and the other in the live broadcasting scene, it is impossible to identify the specific person because there are two specific persons with different voices. This makes the determination that the two voices are different unreliable, and, thereby, it becomes impossible to change the recording start time accurately.

A programmed recording management apparatus described in JP-A-2001-1555393 compiles programmed recording information based on the EPG (Electronic Program Guide) and manages it, determines if there is a possible change in the scheduled broadcasting time, and notifies such a possible change when the program having such a possible change is timer recorded. However, this publication does not disclose how the recording end time for the target program to be recorded is changed when the broadcasting time for the previous program is extended or how the recording end time for the target program in recording is changed when the broadcasting of the target program is extended.

JP-A-H11-296930 discloses an automatic recording apparatus in which, if the previous program immediately preceding the target program to be recorded is in a stereo audio mode and the target program is in a monaural audio mode and when the previous program immediately preceding the target program is extended, the recording end time set for the target program can be automatically changed in accordance with the extended period. However, if the previous program immediately preceding the target program is in a stereo audio mode and the target program is also in a stereo audio mode, or if the previous program immediately preceding the target program is in a monaural audio mode and the target program is also in a monaural audio mode, the recording end time in the programmed recording can not be changed.

### SUMMARY OF THE INVENTION

In order to solve the problems described above, it is an object of the present invention to provide an information recording/reproducing apparatus having a function of changing a programmed recording end time if broadcasting of a program in recording is extended and a function of changing programmed recording start time and end time if broadcasting of a program preceding the program to be recorded is extended.

To achieve the above object, an information recording/reproducing apparatus for recording and reproducing a television program and other information to and from a recording medium, the apparatus comprising: a timer recording programming section for programming timer recording of a desired television program as a target program based on EPG (Electronic Program Guide) information transmitted from a broadcasting station, turning on a first extension flag when it is determined based on target program extension information included in the EPG information that there is a possible extension in broadcasting of the target program, and turning on a second extension flag when it is determined based on previous program extension information included in the EPG information that there is a possible extension in broadcasting of a previous program preceding the target program; a previous program extension coping recording time programming section for, after completion of programming timer recording by the timer recording programming section, periodically monitoring the EPG information when the second extension flag is turned on, and delaying a programmed recording start time and a programmed recording end time for the target program by an amount of time indicated by the previous program extension information when there is the previous program extension information for the previous program in the EPG information that is monitored; and a target program extension coping recording time programming section for, after the programmed recording start time arrives and recording of the target program is started, for periodically monitoring the EPG information when the first extension flag is turned on, and delaying the programmed recording end time for the target program by an amount of time indicated by the target program extension information when there is the target program extension information in the EPG information that is monitored.

According to this configuration, due to processing by the timer recording programming section and the target program extension coping recording time programming section, even if broadcasting for a timer recorded program is extended during recording, it is possible to change the programmed recording end time for the program in recording. Therefore, it is possible to record the program that has been timer recorded until the end of the program, which adds ease of use for the user. Furthermore, due to processing by the timer recording programming section and the previous program extension coping recording time programming section, even if broadcasting for the previous program preceding the program that has been timer recorded is extended, it is possible to change the programmed recording start and end times for the program that has been set for timer recording. Therefore, it is possible to record the program that has been set for timer recording until the end of the program even if the broadcasting of previous program preceding the program set in timer recording is extended, which adds ease of use for the user.

### BRIEF DESCRIPTION OF THE DRAWINGS

FIG. 1 is a block diagram showing a configuration of a combination-type recording/reproducing apparatus representing an information recording/reproducing apparatus of one embodiment of the present invention;

FIG. 2 is an illustration showing one example of a program list displayed on a display unit based on EPG information;

FIG. 3 is a flowchart for explaining a process of programming the timer recording in the combination-type recording/reproducing apparatus;

FIG. 4 is a flowchart for explaining a process of programming the recording time to respond to a possible extension of a previous program in the combination-type recording/reproducing apparatus; and

FIG. 5 is a flowchart for explaining a process of programming the recording time to respond to a possible extension of a target program in the combination-type recording/reproducing apparatus.

### DETAILED DESCRIPTION OF PREFERRED EMBODIMENTS

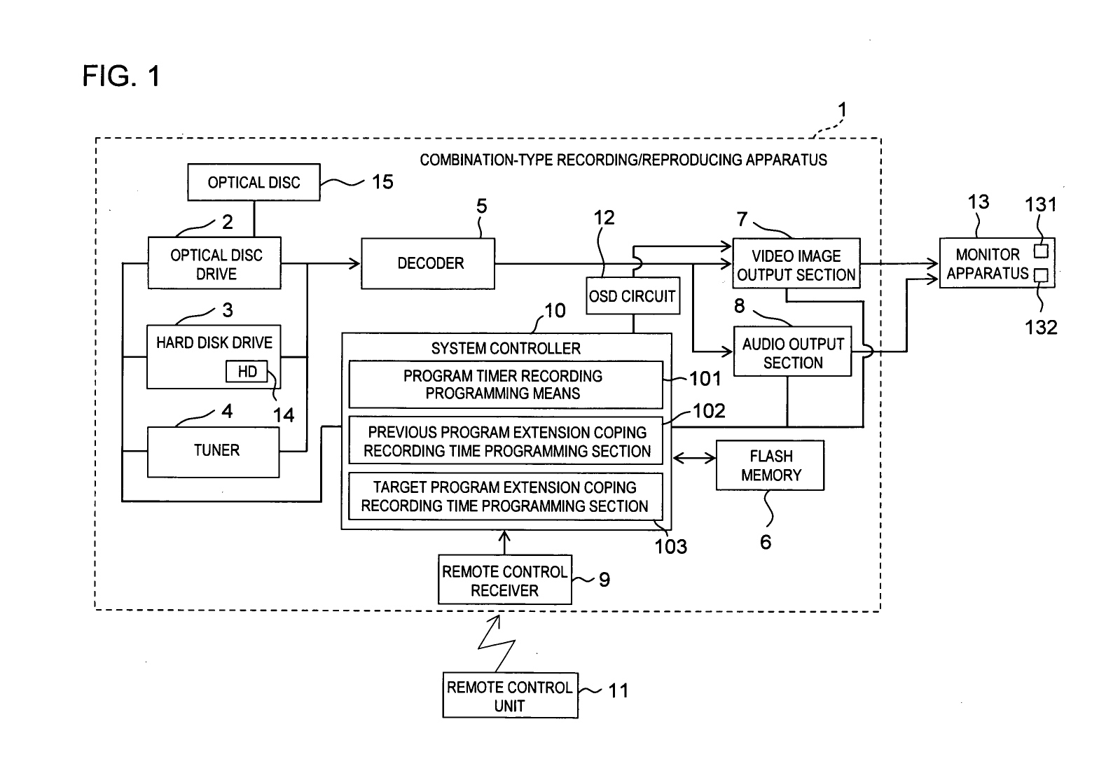

Hereinafter, the embodiments of the present invention will be described with reference to the accompanying drawings. FIG. 1 is a block diagram showing a configuration of a combination-type recording/reproducing apparatus representing an information recording/reproducing apparatus of one embodiment of the present invention. Although a combination-type recording/reproducing apparatus incorporating a hard disk drive and an optical disc drive is described hereunder, the features characterized in this embodiment, i.e., a function of programming the timer recording and a function of changing programmed recording start time and end time, may be provided to a non-combination-type apparatus such as a hard disk recording/reproducing apparatus or an optical disc recording/reproducing apparatus to achieve the same advantageous effect.

In FIG. 1, a combination-type recording/reproducing apparatus 1 comprises: an optical disc drive 2 for recording and reproducing information to and from an optical disc 15; a hard disk drive 3 for recording and reproducing information to and from an HD (hard disk) 14; a tuner 4 for receiving television broadcast signals via unillustrated antenna and selecting a television broadcast signal of a desired channel to output as a video/audio signal; a decoder 5 for decoding a video/audio signal fed out from the optical disc drive 2 or the hard disk drive 3; and a flash memory 6 for memorizing broadcast channels that can be received by the tuner 4 and programs etc. required for the operation of a system controller 10.

In addition, the combination-type recording/reproducing apparatus 1 further comprises: a video image output section 7 for converting the video signal decoded by the decoder 5 into a video signal that can be displayed on a display unit 131 of a monitor apparatus (such as a television receiver) 13; an OSD (On Screen Display) circuit 12 for displaying a playback list screen or a television program list on the display unit 131 of the monitor apparatus 13; an audio output section 8 for converting the audio signal decoded by the decoder 5 into an audio signal that can be output by a speaker 132 of the monitor apparatus 13; a remote control receiver 9 for receiving various command signals transmitted in infrared light from a remote control unit 11, converting the command signals in infrared light into electric command signals, and feeding out the converted command signals to the system controller 10; and the system controller 10 for controlling the apparatus as a whole.

The system controller 10 includes a feature characterized in this embodiment, i.e., a timer recording programming section 101 that comprises: program timer recording programming means for setting timer recording of a desired television program as a target program based on the EPG information transmitted from a broadcasting station; first extension/non-extension determination means for determining whether or not there is a possible extension of broadcasting of the target program based on target program extension information included in the EPG information; first extension flag activation means for turning on a first extension flag when it is determined that there is a possible extension of the target program; second extension/non-extension determination means for determining whether or not there is a possible extension of broadcasting of the previous program preceding the target program based on previous program extension information included in the EPG information; and second extension flag activation means for turning on a second extension flag when it is determined that there is a possible extension of the previous program preceding the target program.

The system controller 10 further includes a previous program extension coping recording time programming section 102 which comprises: second extension flag determination means for determining whether or not the second extension flag is turned on after the setting of the timer recording is completed by the timer recording programming section 101; previous program EPG monitoring means for periodically monitoring the EPG information when it is determined that the second extension flag is turned on; previous program extension information presence/non-presence determination means for determining whether or not there is previous program extension information in the monitored EPG information; and programmed recording start/end times changing means for delaying the programmed recording start and end times for the target program by an amount of time indicated by the previous program extension information when it is determined that there is the previous program extension information in the monitored EPG information.

The system controller 10 further includes a target program extension coping recording time programming section 103 which comprises: first extension flag determination means for determining whether or not the first extension flag is turned on after the recording of the target program is started when the programmed recording start time arrives; target program EPG monitoring means for periodically monitoring the EPG information when it is determined that the first extension flag is turned on; target program extension information presence/non-presence determination means for determining whether or not there is target program extension information in the monitored EPG information; and programmed recording end time changing means for delaying the programmed recording end time for the target program by an amount of time indicated by the target program extension information when it is determined that there is the target program extension information in the monitored EPG information.

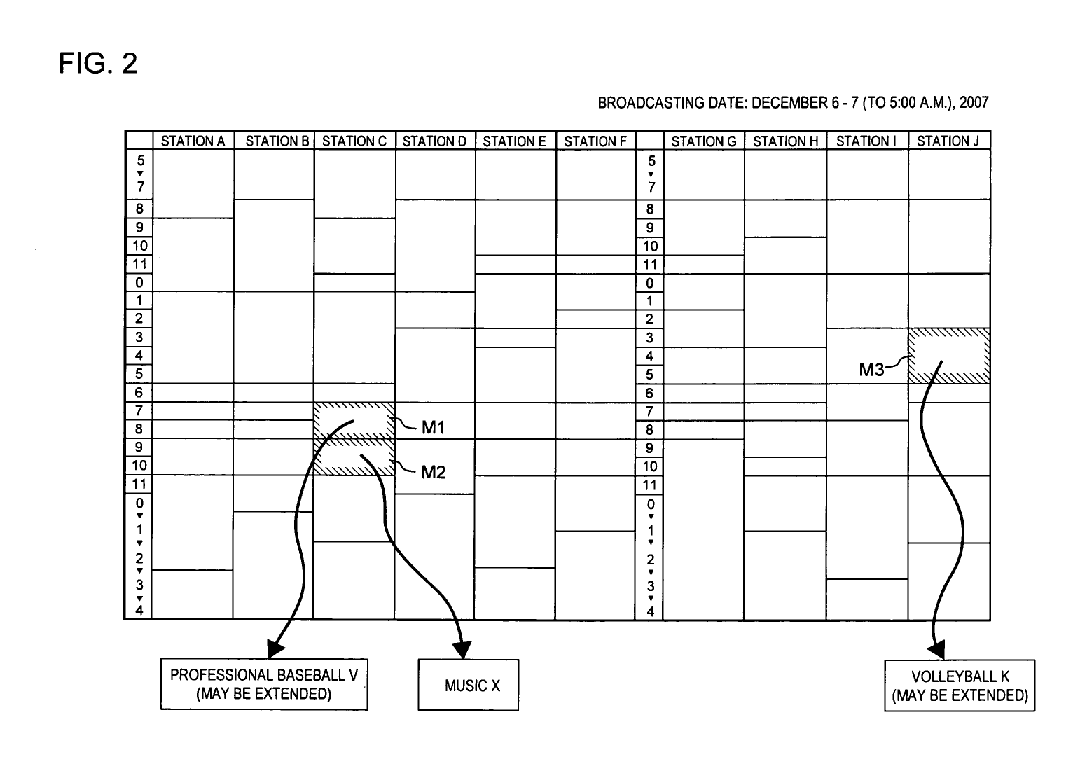

FIG. 2 is an illustration showing one example of a television program list displayed on the display unit based on the EPG information. In this program list, broadcasting station names are shown horizontally and broadcasting time zones are shown vertically. Although most of program names are omitted in this program list, a program indication frame M1 shows “Professional baseball V (may be extended)”, a program indication frame M2 shows “Music X”, and a program indication frame M3 shows “Volleyball K (may be extended)”. Here, it is also possible to indicate “may be extended up to 30 minutes” instead of the message “may be extended”.

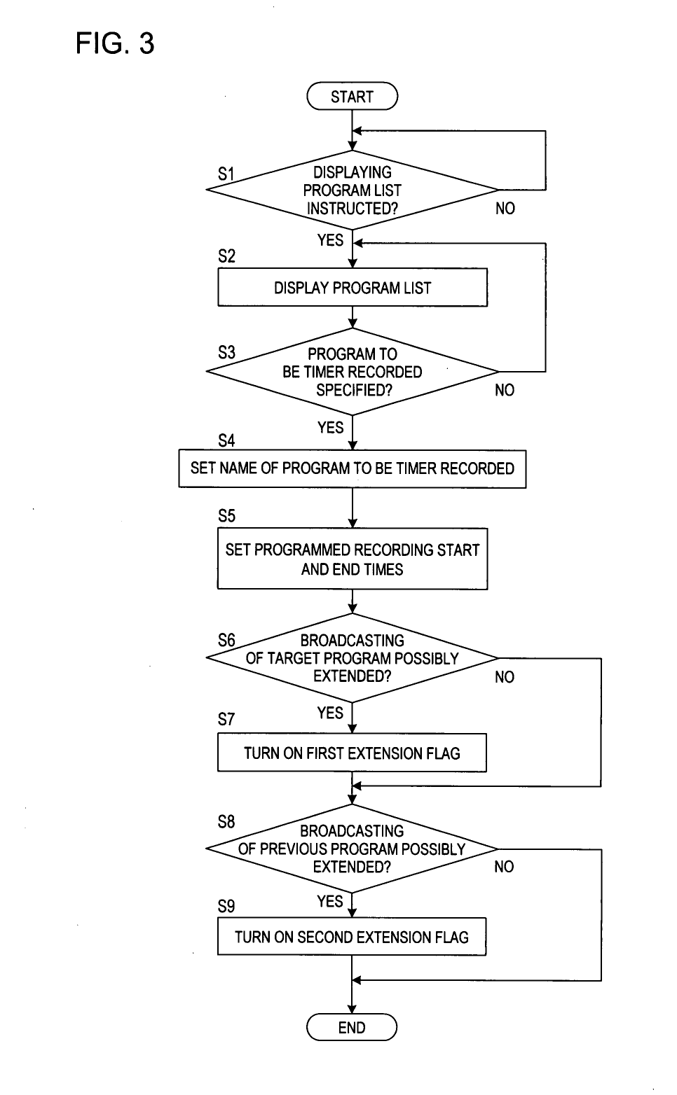

FIG. 3 is a flowchart for explaining a process of programming the timer recording in the combination-type recording/reproducing apparatus. Here, a description is given by assuming that TV programs are recorded on a hard disk. However, the system controller of the combination-type recording/reproducing apparatus performs similar control over processing for programming the timer recording when TV programs are recorded on an optical disc (DVD). Hereinafter, a description is given of the processing for programming the timer recording with reference to this flowchart and FIGS. 1 and 2.

First, the user presses down a program list key of the remote control unit 11 so that a program list using the EPG is displayed on the display unit 131 of the monitor apparatus 13. Then, the system controller 10 detects that a command for displaying the program list has been issued (Step S1). In response to this, the EPG data transmitted from a broadcasting station tuned in to by the tuner 4 is obtained. The system controller 10 performs control so that the EPG data is subjected to OSD processing in the OSD circuit 12, in addition, converted into a video signal that can be displayed on the display unit 131, and displayed on the display unit 131 as a program list (refer to FIG. 2) based on the EPG data (Step S2).

Then, the user, while watching the program list displayed on the display unit 131, operates the up, down, left, or right direction key on the remote control unit 11 to select a program to be timer recorded and presses down the enter key. In response to this, the program timer recording programming means 101 of the system controller 10 detects that a program to be timer recorded has been specified (Step S3), sets the name of the program (target program) to be timer recorded into the flash memory 6 (Step S4), and further sets the programmed recording start and end times of the target program into the flash memory 6 (Step S5). The system controller 10 also performs control in such a way that a displaying color in a program indication frame is displayed, for example, in green or blue for easy distinction of the program that has been set for timer recording in the program list.

Here, a description is given by assuming, for easy understanding, that, in the program list shown in FIG. 2, a target program which the user wants to record is a music program X of a broadcasting station C and that a program to be broadcast immediately before the music program X is a professional baseball program V. It is also assumed that another target program which the user wants to record is a volleyball program K. In this assumption, the professional baseball program V and the volleyball program K are the programs that may be extended in broadcasting.

The first extension/non-extension determination means of the timer recording programming section 101 determines whether or not it is possible that the broadcasting of the timer recorded program will be extended based on the target program extension information contained in the EPG information (Step S6). In this example, as shown in the program list in FIG. 2, a message “may be extended” is indicated in the program indication frame M3 showing the program name of the timer recorded program, “Volleyball program K”. This means that the EPG information includes the target program extension information regarding the volleyball program K. Therefore, the first extension/non-extension determination means determines that the broadcasting of the volleyball program K will possibly be extended. Also, as shown in the program list in FIG. 2, a message “may be extended” is not displayed in the program indication frame M2 showing “Music X” that is the name of the program set for timer recording. This means that the target program extension information for the Music X is not contained in the EPG information. Therefore, the first extension/non-extension determination means determines that the broadcasting of the Music X will not be extended. As a result, the first extension flag activation means of the timer recording programming section 101 turns on the first extension flag for the recording of the Volleyball program K which has been determined as being possibly extended (Step S7).

Next, the second extension/non-extension determination means of the timer recording programming section 101 determines whether or not there is a possible extension in broadcasting of the previous program preceding the target program that has been programmed for recording based on the previous program extension information included in the EPG information (Step S8). In this example, the previous program that is broadcast before the Music X is the Professional baseball V which will possibly be extended. Accordingly, the second extension/non-extension determination means determines that there is a possible extension in broadcasting of the Professional baseball V based on the previous program extension information included in the EPG information and corresponding to the Professional baseball V. As explained above, when it is determined that there is a possible extension in broadcasting of the previous program preceding the target program, the second extension flag activation means of the timer recording programming section 101 turns on the second extension flag in correspondence with the Professional baseball V (Step S9). This completes the processing by the timer recording programming section 101. Here, it is to be noted that the previous program before the target program which is programmed for recording by a user is not limited to a program immediately preceding the target program, but may be any other programs that are broadcast before the target program in terms of time.

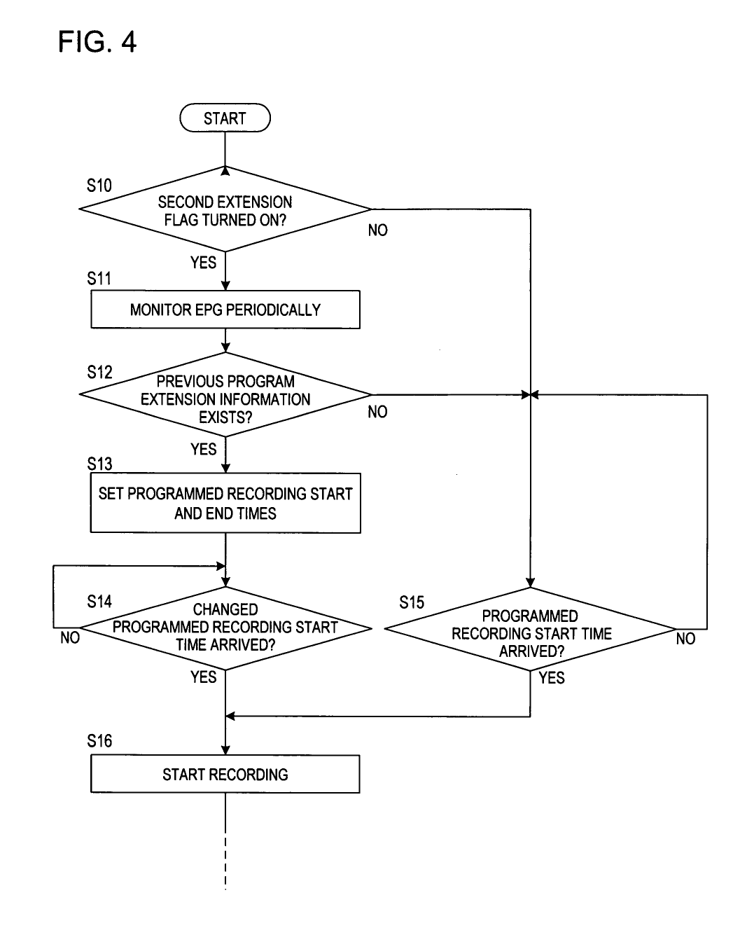

FIG. 4 is a flowchart for explaining a process of programming the recording time to respond to a possible extension of a previous program in the combination-type recording/reproducing apparatus. Now, with reference to this flowchart and FIG. 1, a description will be given of the process of programming the recording time to respond to a possible extension of a previous program.

First, after the setting of the timer recording is completed by the timer recording programming section 101, the second extension flag determination means of the previous program extension coping recording time programming section 102 determines whether the broadcasting of a previous program preceding the target program which a user desires to record will possibly be extended or not. To do this, it is checked if the second extension flag is turned on or not (Step S10). In this example, since the broadcasting of the Professional baseball V preceding the Music X which the user wishes to record will possibly be extended, the second extension flag corresponding to the Professional baseball V is turned on.

When it is determined that the second extension flag is turned on, the previous program EPG monitoring means of the previous program extension coping recording time programming section 102 monitors the EPG information periodically, e.g., monitors every 10 minutes to see if the EPG information is updated (Step S11). Then, the previous program extension information presence/non-presence determination means of the previous program extension coping recording time programming section 102 determines whether or not there is previous program extension information present in the monitored EPG information (Step S12).

When it is determined that there is the previous program extension information present in the EPG information, the programmed recording start/end times changing means of the previous program extension coping recording time programming section 102 delays the programmed recording start and end times of the target program by an amount of time indicated by the previous program extension information (Step S13). For example, if the end of the broadcasting of the Professional baseball V is delayed by 30 minutes than it is scheduled, then it is understood before hand through the previous program extension information included in the EPG information that the broadcasting of the Professional baseball V will end at 9:30 p.m. To be specific, the previous program extension information corresponding to the Professional baseball V indicates that the broadcasting thereof will be extended by additional 30 minutes. Accordingly, the programmed recording start/end times changing means changes the programmed recording start time and end time for the Music X to 9:30 p.m. and 11:30 p.m., respectively. However, the programmed recording start and end times may not be set accurately so as to reflect the actual situation, because a maximum extension period of 30 minutes means that the broadcasting of the Professional baseball V may sometimes end, for example, after a 20-minute extension.

Thereafter, when the system controller 10 determines that the current time kept by an unillustrated timer reaches the changed programmed recording start time, the system controller 10 controls the hard disk drive 3 to perform a recording operation so that, for example, the Music X is started to be recorded on the HD 14 (Step S16). With this arrangement, it is possible to record the entire program of the Music X.

Note that, when it is determined that the second extension flag is not turned on in step S10 or when it is determined that there is no extension in broadcasting of the previous program in step S12, the recording will start as scheduled (Step S16) when the current time reaches the programmed recording start time (Step S15) because there is no need to change the programmed recording start time for the target program. For example, when the broadcasting of the Professional baseball V ends as scheduled at 9:00 p.m., the programmed recording start time for the Music X remains unchanged at 9:00 p.m. and the recording thereof will start at 9:00 p.m.

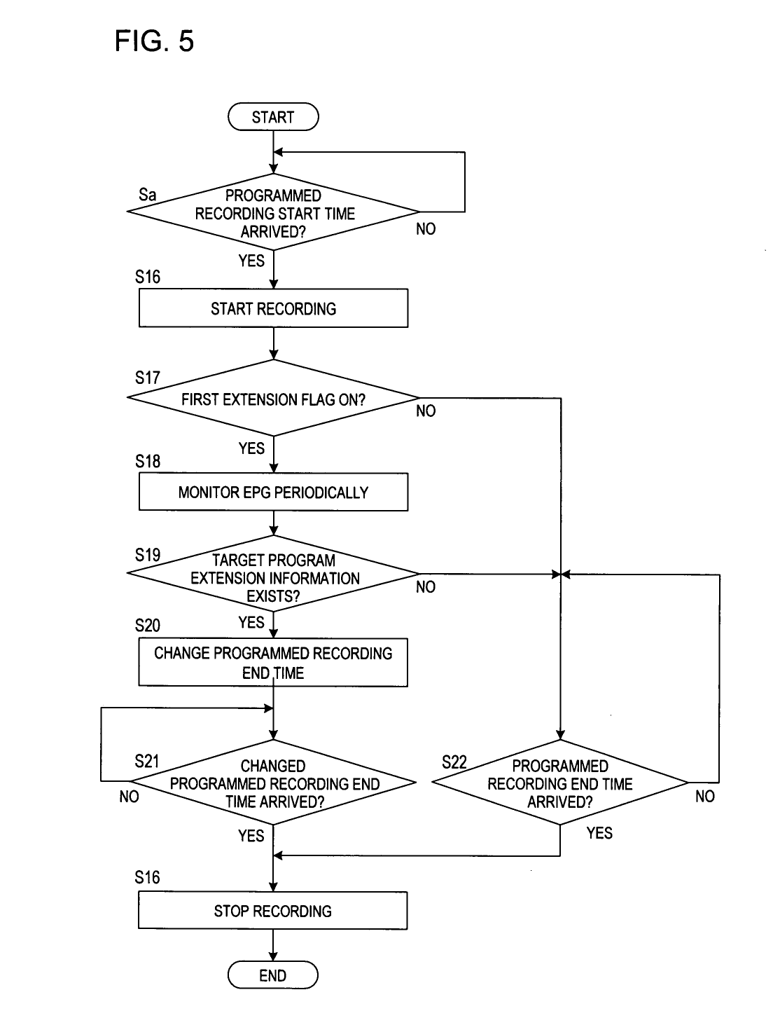

FIG. 5 is a flowchart for explaining a process of programming the recording time to respond to a possible extension of a target program in the combination-type recording/reproducing apparatus of the embodiment. Now, with reference to this flowchart and FIG. 1, a description will be given of the process of programming the recording time to respond to a possible extension of a target program.

When the programmed recording start time arrives (Step Sa), the recording of the target program starts (Step S16). Thereafter, the first extension flag determination means of the target program extension coping recording time programming section 103 determines whether or not the first extension flag is turned on (Step S17). Here, step Sa in FIG. 5 corresponds to step S14 or S15 in FIG. 4, and step S16 in FIG. 5 corresponds to step S16 in FIG. 4.

Next, when it is determined that the first extension flag is turned on, the target program EPG monitoring means of the target program extension coping recording time programming section 103 monitors the EPG information periodically, e.g., monitors every 10 minutes to see if the EPG information is updated (Step S18). Then, the target program extension information presence/non-presence determination means of the target program extension coping recording time programming section 103 determines whether or not there is target program extension information present in the monitored EPG information (Step S19).

When it is determined that there is the target program extension information present in the monitored EPG information, the programmed recording end time changing means of the target program extension coping recording time programming section 103 delays the programmed recording end time for the target program by an amount of time indicated by the target program extension information (Step S20). For example, if the end of the broadcasting of the Volleyball K is delayed by 30 minutes from the original schedule and ends at 6:30 p.m., the programmed recording end time changing means changes the programmed recording end time for Volleyball K to 6:30 p.m. because the target program extension information corresponding to the Volleyball K indicates a 30-minumte extension.

Thereafter, when the system controller 10 determines that the changed programmed recording end time arrives, the system controller 10 controls the hard disk drive 3 to stop the recording operation of the target program (Step S23). With this arrangement, it is possible to record the entire program of the Volleyball K even if, for example, the broadcasting of the Volleyball K is extended and the end time thereof is delayed.

Note that, when it is determined that the first extension flag is not turned on in step S17 or when it is determined that there is no extension of broadcasting of the target program in step S19, there is no need to change the programmed recording end time for the target program. Accordingly, the recording will end as scheduled (Step S23) when the programmed recording end time arrives (Step S22). For example, when the broadcasting of the Volleyball K ends as scheduled at 6:00 p.m., and the recording thereof stops at 6:00 p.m.

As described above, according to this embodiment, it is possible to automatically change the programmed recording end time through processing by the timer recording programming section 101 and the target program extension coping recording time programming section 103 when the broadcasting of the program in recording is extended. With this arrangement, it is possible to timer record the entire program until the end even if the broadcasting of the program in timer recording is extended outside the schedule. This also contributes to the ease of use by the user. It is also possible to change the programmed recording start and end times through processing by the timer recording programming section 101 and the previous program extension coping recording time programming section 102 when the broadcasting of the previous program preceding the target program that is set for timer recording is extended. With this arrangement, it is possible to timer record the entire program until the end even if the broadcasting of the previous program preceding the target program that is set for timer recording is extended outside the schedule. This also contributes to the ease of use by the user.

What is claimed is:

1. An information recording/reproducing apparatus for recording and reproducing a television program and other information to and from a recording medium, the apparatus comprising:
a timer recording programming section for programming timer recording of a desired television program as a target program based on EPG (Electronic Program Guide) information transmitted from a broadcasting station, turning on a first extension flag when it is determined based on target program extension information included in the EPG information that there is a possible extension in broadcasting of the target program, and turning on a second extension flag when it is determined based on previous program extension information included in the EPG information that there is a possible extension in broadcasting of a previous program preceding the target program;
a previous program extension coping recording time programming section for, after completion of programming timer recording by the timer recording programming section, periodically monitoring the EPG information when the second extension flag is turned on, and delaying a programmed recording start time and a programmed recording end time for the target program by an amount of time indicated by the previous program extension information when there is the previous program extension information for the previous program in the EPG information that is monitored; and
a target program extension coping recording time programming section for, after the programmed recording start time arrives and recording of the target program is started, for periodically monitoring the EPG information when the first extension flag is turned on, and delaying the programmed recording end time for the target program by an amount of time indicated by the target program extension information when there is the target program extension information in the EPG information that is monitored.

2. The information recording/reproducing apparatus according to claim 1,
wherein the timer recording programming section comprises:
program timer recording programming means for setting timer recording of a desired television program as the target program based on the EPG information transmitted from a broadcasting station;
first extension/non-extension determination means for determining, based on the target program extension information included in the EPG information, whether or not there is a possible extension in broadcasting of the target program;
first extension flag activation means for turning on the first extension flag when it is determined that there is a possible extension in broadcasting of the target program;
second extension/non-extension determination means for determining, based on previous program extension information included in the EPG information, whether or not there is a possible extension in broadcasting of the previous program preceding the target program; and
second extension flag activation means for turning on the second extension flag when it is determined that there is a possible extension in broadcasting of the previous program preceding the target program.

3. The information recording/reproducing apparatus according to claim 1,
wherein the previous program extension coping recording time programming section comprises:
second extension flag determination means for, after completion of programming timer recording by the timer recording programming section, determining whether or not the second extension flag is turned on;
previous program EPG monitoring means for periodically monitoring the EPG information when it is determined that the second extension flag is turned on;
previous program extension information presence/non-presence determination means for determining whether or not there is the previous program extension information in the EPG information that is monitored; and
programmed recording start/end times changing means for delaying the programmed recording start time and the programmed recording end time for the target program by an amount of time indicated by the previous program extension information when it is determined that there is the previous program extension information in the EPG information that is monitored.

4. The information recording/reproducing apparatus according to claim 1,
the target program extension coping recording time programming section comprises:
first extension flag determination means for determining whether or not the first extension flag is turned on after recording for the target program is started when the programmed recording start time arrives;
target program EPG monitoring means for periodically monitoring the EPG information when it is determined that the first extension flag is turned on;
target program extension information presence/non-presence determination means for determining whether or not there is the target program extension information in the EPG information that is monitored; and
programmed recording end time changing means for delaying the programmed recording end time for the target program by an amount of time indicated by the target program extension information when it is determined that there is the target program extension information in the EPG information that is monitored.

5. An information recording/reproducing apparatus for recording and reproducing a television program and other information to and from a recording medium, the apparatus comprising:
a timer recording programming section including:
program timer recording programming means for setting timer recording of a desired television program as a target program based on EPG (Electronic Program Guide) information transmitted from a broadcasting station;
first extension/non-extension determination means for determining, based on target program extension information included in the EPG information, whether or not there is a possible extension in broadcasting of the target program;
first extension flag activation means for turning on a first extension flag when it is determined that there is a possible extension in broadcasting of the target program;
second extension/non-extension determination means for determining, based on previous program extension information included in the EPG information, whether or not there is a possible extension in broadcasting of a previous program preceding the target program; and
second extension flag activation means for turning on a second extension flag when it is determined that there is a possible extension in broadcasting of the previous program preceding the target program,
a previous program extension coping recording time programming section including:
second extension flag determination means for, after completion of programming timer recording by the timer recording programming section, determining whether or not the second extension flag is turned on;
previous program EPG monitoring means for periodically monitoring the EPG information when it is determined that the second extension flag is turned on;
previous program extension information presence/non-presence determination means for determining whether or not there is the previous program extension information in the EPG information that is monitored; and
programmed recording start/end times changing means for delaying the programmed recording start time and programmed recording end time for the target program by an amount of time indicated by the previous program extension information when it is determined that there is the previous program extension information in the EPG information that is monitored,
a target program extension coping recording time programming section including:
first extension flag determination means for determining whether or not the first extension flag is turned on after recording for the target program is started when the programmed recording start time arrives;
target program EPG monitoring means for periodically monitoring the EPG information when it is determined that the first extension flag is turned on;
target program extension information presence/non-presence determination means for determining whether or not there is the target program extension information in the EPG information that is monitored; and
programmed recording end time changing means for delaying the programmed recording end time for the target program by an amount of time indicated by the target program extension information when it is determined that there is the target program extension information in the EPG information that is monitored.
